(19) United States
(12) Patent Application Publication
(10) Pub. No.: US 2018/0018121 A1
(43) Pub. Date: Jan. 18, 2018

(54) NON-TRANSITORY COMPUTER-READABLE STORAGE MEDIUM, MEMORY MANAGEMENT DEVICE, AND MEMORY MANAGING METHOD

(71) Applicant: FUJITSU LIMITED, Kawasaki-shi (JP)

(72) Inventor: Kenji Kazumura, Mishima (JP)

(73) Assignee: FUJITSU LIMITED, Kawasaki-shi (JP)

(21) Appl. No.: 15/641,466

(22) Filed: Jul. 5, 2017

(30) Foreign Application Priority Data
Jul. 14, 2016 (JP) 2016-139246

(51) Int. Cl. G06F 3/06

(52) U.S. Cl. CPC G06F 3/0635; G06F 3/0673; G06F 3/065; G06F 12/1027; G06F 3/0604; G06F 3/0652; G06F 2212/1024; G06F 2212/68

(57) ABSTRACT

A non-transitory computer-readable storage medium storing a memory management program that causes a computer to execute a process, the process including when a request indicating that data at a first address within a first memory region of a memory is an access destination is received from a process of a software during a time period from the start to end of a data movement processing, obtaining a second address within a second memory region of the memory, the data movement processing including moving data stored in the first memory region to the second memory region, and changing the access destination of the request from the first address to the second address.

### CROSS-REFERENCE TO RELATED APPLICATION

This application is based upon and claims the benefit of priority of the prior Japanese Patent Application No. 2016-139246, filed on Jul. 14, 2016, the entire contents of which are incorporated herein by reference.

### FIELD

The embodiment discussed herein is related to a non-transitory computer-readable storage medium, a memory management device, and a memory managing method.

### BACKGROUND

When garbage collection is executed on a memory, a process of an application is stopped in order to avoid an inconsistency in data. The relationship between the garbage collection and the process of the application is described with reference to FIG. 1. In an example illustrated in FIG. 1, when the process of the application is stopped, the garbage collection is started and object copying is executed. In the example illustrated in FIG. 1, an object A that is a live object is copied from an old region to a new region. When the garbage collection is terminated, the process of the application is restarted.

If the capacity of the memory is approximately several gigabytes (GB), copying garbage collection (GC) may be used and a time period for stopping the process of the application may be suppressed to a range of several tens of milliseconds to several hundreds of milliseconds. However, if the capacity of the memory is approximately several terabytes (TB) and the copying GC or the like is used, the time period for stopping the process of the application may be in a range of several seconds to several minutes.

A certain document has disclosed a technique for reducing the time period for stopping the process of the application in the garbage collection. Specifically, in a phase of copying the object, a generation region in which the object to be copied exists is set to be a read-only region. This setting inhibits reading access by the application from being stopped and suppresses the stop of the process of the application.

An example of related art is Japanese Laid-open Patent Publication No. 2014-044472.

### SUMMARY

According to an aspect of the invention, a non-transitory computer-readable storage medium storing a memory management program that causes a computer to execute a process, the process including when a request indicating that data at a first address within a first memory region of a memory is an access destination is received from a process of a software during a time period from the start to end of a data movement processing, obtaining a second address within a second memory region of the memory, the data movement processing including moving data stored in the first memory region to the second memory region, and changing the access destination of the request from the first address to the second address.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram describing the relationship between garbage collection and a process of an application;

FIG. 2 is a diagram illustrating a hardware configuration of an information processing device;

FIG. 3 is a diagram illustrating a hardware configuration of each of CPU cores;

FIG. 4 is a diagram describing the use of a memory according to an embodiment;

FIG. 5A is a diagram illustrating an example of a program stored in an HDD;

FIG. 5B is a functional block diagram of a GC handler;

FIG. 6 is a diagram illustrating the flow of a process to be executed by a garbage collector;

FIG. 7 is a diagram illustrating the flow of a process to be executed upon the issuance of a load command or a store command;

FIG. 8 is a diagram describing access executed in accordance with the load command or the store command;

FIG. 9 is a diagram illustrating the flow of a detection process;

FIG. 10 is a diagram describing the copying of an access attribute value;

FIG. 11 is a diagram describing the determination of whether or not access is possible;

FIGS. 12A, 12B, and 12C are diagrams describing garbage collection according to the embodiment; and

FIG. 13 is a diagram describing a reduction in a time period for stopping.

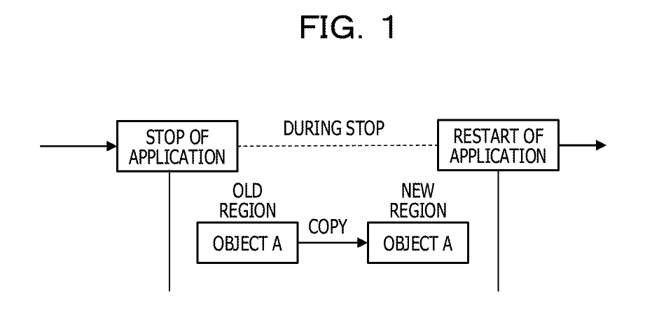

### DESCRIPTION OF EMBODIMENT

Even if the aforementioned technique is used, the time period for stopping the application may not be sufficiently reduced due to overhead upon access or the like.

According to an aspect, an object of the present disclosure is to provide a technique for reducing a time period for stopping an application due to garbage collection.

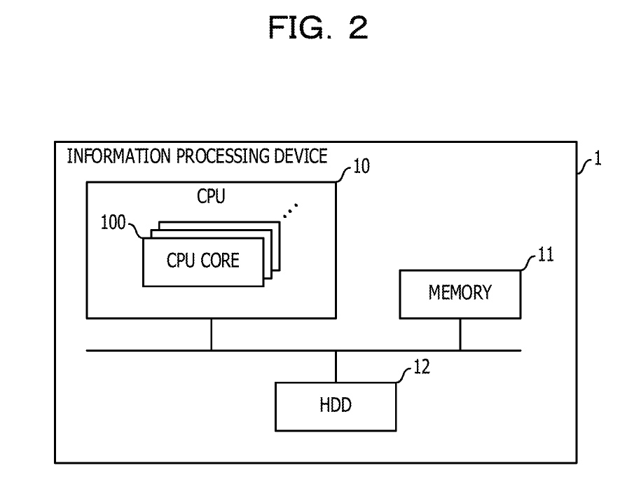

FIG. 2 is a diagram illustrating a hardware configuration of an information processing device 1 according to an embodiment. The information processing device 1 includes a central processing unit (CPU) 10, a memory 11, and a hard disk drive (HDD) 12. The memory 11 is, for example, a dual inline memory module (DIMM). The CPU 10 includes a plurality of CPU cores 100. The information processing device 1 is a personal computer, a server, a smartphone, or the like, for example. Instead of the HDD 12, a storage device such as a solid state drive (SSD) may be used.

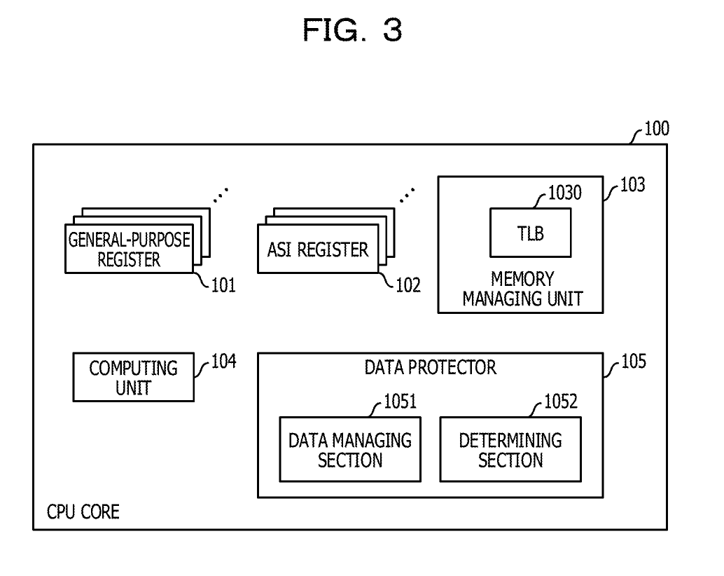

FIG. 3 is a diagram illustrating a hardware configuration of each of the CPU cores 100. Each of the CPU cores 100 includes one or more general-purpose registers 101, one or more address space identifier (ASI) registers 102, a memory managing unit 103, a computing unit 104, and a data protector 105. In the general-purpose registers 101, data to be used for a process to be executed by the computing unit 104 or the like is stored. In each of the ASI registers 102, an access key that indicates an issuer of either or both of a load command and a store command is stored. The memory managing unit 103 includes a translation lookaside buffer (TLB) 1030 and manages the memory 11. The computing unit 104 executes a command. The data protector 105 includes a data managing section 1051 and a determining section 1052. The data protector 105 is a hardware module included in a control device of the CPU core 100, for example. The CPU core 100 may include a register other than the general-purpose registers 101 and the ASI registers 102.

The data managing section 1051 executes a process of acquiring an access attribute value stored in the memory 11 and an access key based on either or both of a load command and a store command. The determining section 1052 executes, based on the acquired access attribute value and the acquired access key, a process of determining whether or not access is permitted.

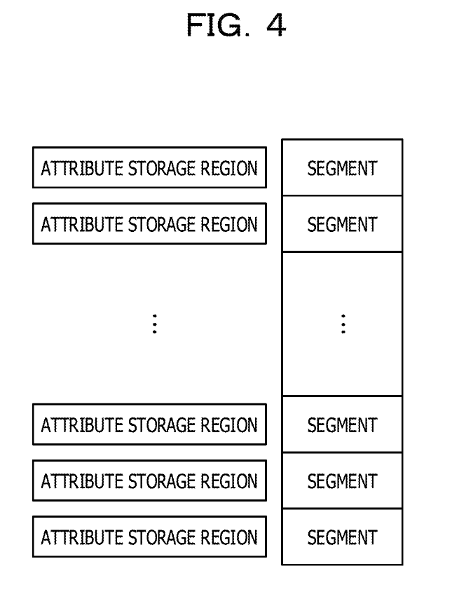

The use of the memory 11 is described with reference to FIG. 4. In the embodiment, the memory 11 is divided into a plurality of segments and used. In the segments, attribute storage regions for storing access attribute values are included. The access attribute values are information indicating whether or not the segments are targeted for garbage collection. The access attribute values are managed by a garbage collector.

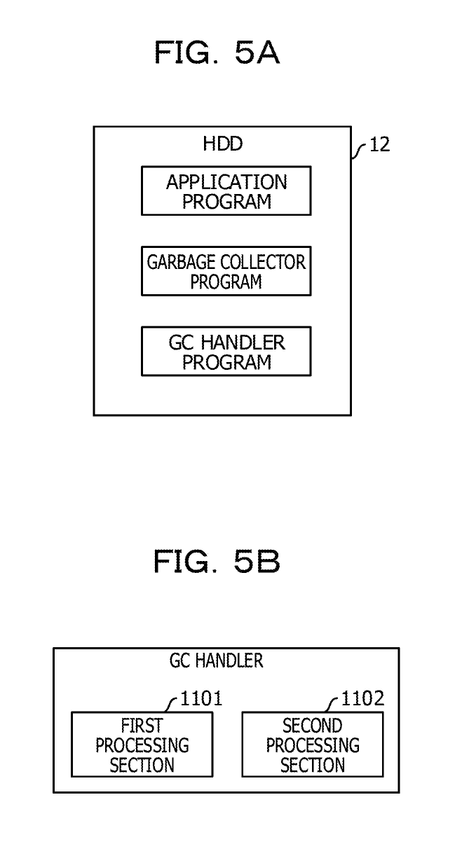

FIG. 5A illustrates an example of programs stored in the HDD 12. In the HDD 12, an application program, a garbage collector program, and a GC handler program are stored. Various functions are achieved by causing the CPU 10 loaded in the memory 11 to execute the programs. Specifically, an application (hereinafter also referred to as mutator) described later is achieved by causing the CPU 10 to execute the application program. The garbage collector described later is achieved by causing the CPU 10 to execute the garbage collector program. A GC handler described later is achieved by causing the CPU 10 to execute the GC handler program. The application, the garbage collector, and the GC handler correspond to processes or threads, for example. The application program, the garbage collector program, and the GC handler program may be stored in a storage device (for example, a read only memory (ROM)) other than the HDD 12.

FIG. 5B is a functional block diagram of the GC handler. In an example illustrated in FIG. 5B, the GC handler includes a first processing section 1101 and a second processing section 1102. The first processing section 1101 and the second processing section 1102 execute processes upon the generation of a hardware exception.

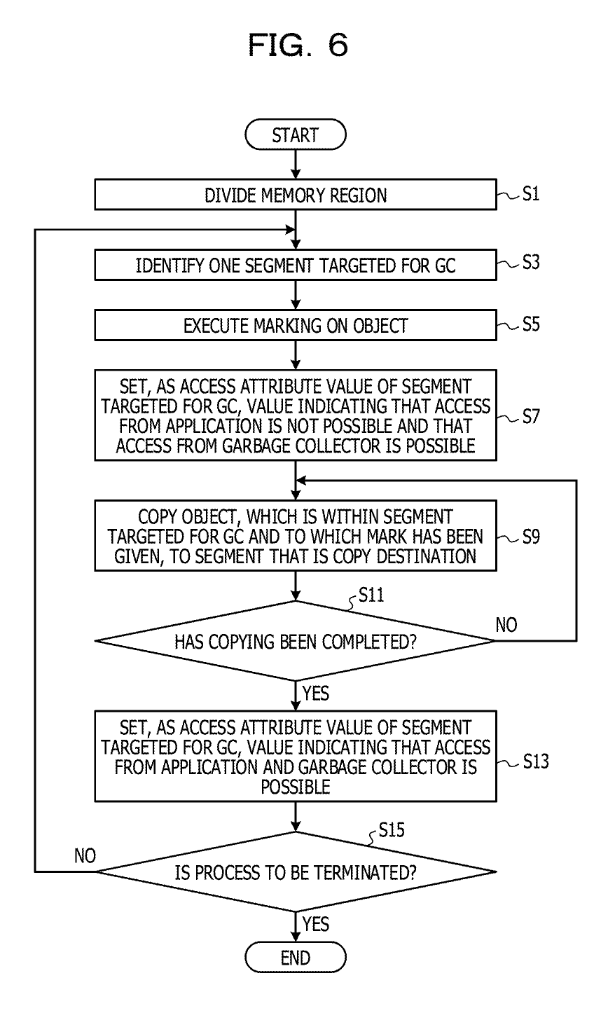

Next, operations of the information processing device 1 are described with reference to FIGS. 6 to 12C.

First, a process to be executed by the garbage collector is described with reference to FIG. 6.

The garbage collector divides a region of the memory 11 into a plurality of segments (in step S1 illustrated in FIG. 6). In step S1, the garbage collector executes a process of setting a start address and end address of each of the segments or the like. The sizes of the segments may be the same as or different from each other.

The garbage collector identifies one segment (hereinafter referred to as GC target segment) targeted for the garbage collection (in step S3).

The garbage collector executes marking on an object within the GC target segment (in step S5). The marking is a process of giving a mark indicating a live object to an object able to be detected by tracing a reference pointer. The live object is an object scheduled not to be used for the application in the future.

The garbage collector sets, in an attribute storage region of the GC target segment as an access attribute value of the GC target segment, a value indicating that access from the application is not possible and that access from the garbage collector is possible (in step S7).

The garbage collector copies, to a segment that is a copy destination, the object that is among objects within the GC target segment and to which the mark has been given (in step S9).

The garbage collector determines whether or not the copying of all objects to which the mark has been given has been completed (in step S11). If the copying of all the objects to which the mark has been given has not been completed (No in step S11), the process returns to step S9.

If the copying of all the objects to which the mark has been given has been completed (Yes in step S11), the garbage collector executes the following process. Specifically, the garbage collector sets, in the attribute storage region of the GC target segment as the access attribute value of the GC target segment, a value indicating that access from the application and the garbage collector is possible (in step S13).

The garbage collector determines whether or not an instruction (for example, an instruction to shut down the information processing device 1) to terminate the process has been provided (in step S15). If the instruction to terminate the process has not been provided (No in step S15), the process returns to step S3. If the instruction to terminate the process has been provided (Yes in step S15), the process is terminated.

By executing the aforementioned process, access from the application to the GC target region may be limited, access from the garbage collector is permitted, and the garbage collection may be normally executed. As described below, the access from the application to the GC target region is not completely prohibited and an increase in a time period for stopping the process of the application may be suppressed.

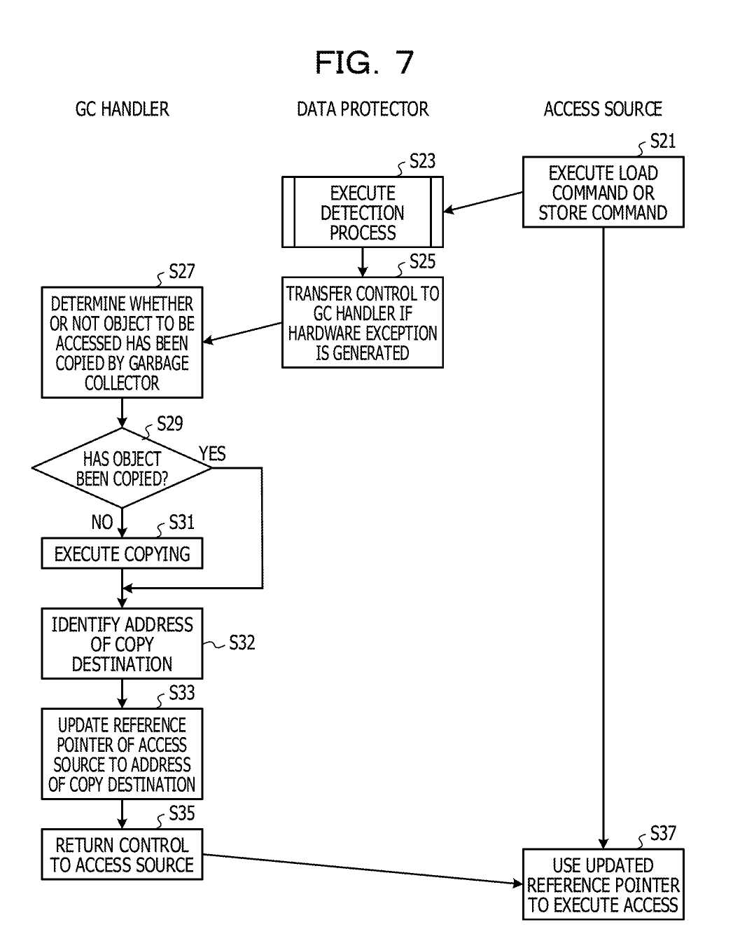

A process to be executed upon the issuance of a load command or a store command is described with reference to FIGS. 7 to 11.

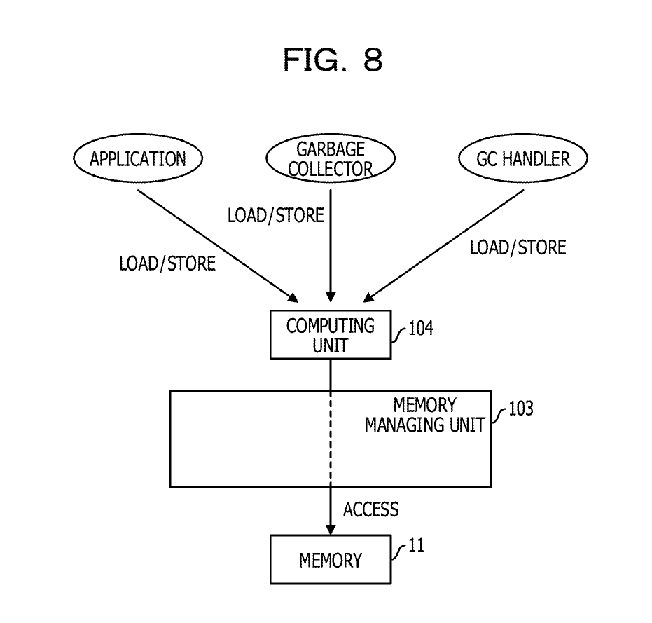

First, an access source (for example, the application, the garbage collector, or the GC handler) issues the load command or the store command (in step S21 illustrated in FIG. 7). The load command is a command to set data stored in the memory 11 in a general-purpose register 101, while the store command is a command to set data stored in the general-purpose register 101 in the memory 11. As illustrated in FIG. 8, a computing unit 104 included in a CPU core 100 accesses the memory 11 via the memory managing unit 103 in accordance with the issued load or store command.

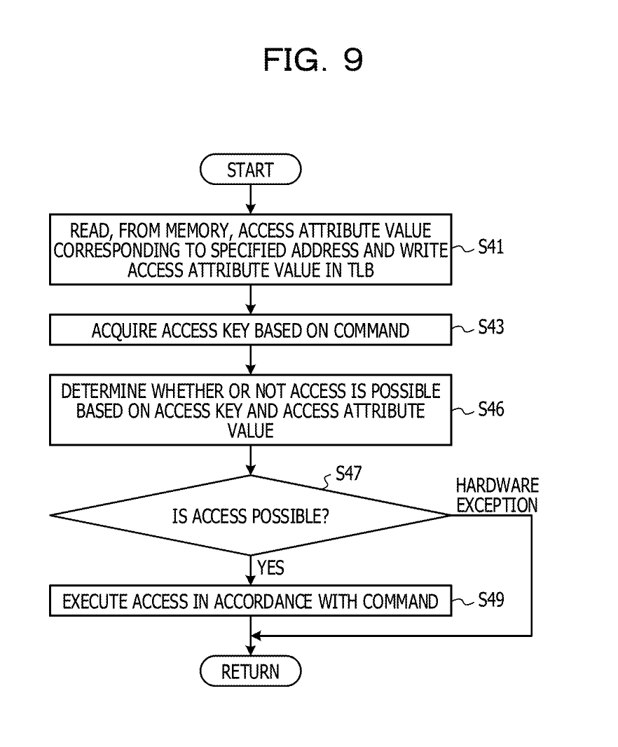

The CPU core 100 that has received the load command or the store command executes a detection process (in step S23). The detection process is described with reference to FIGS. 9 to 11.

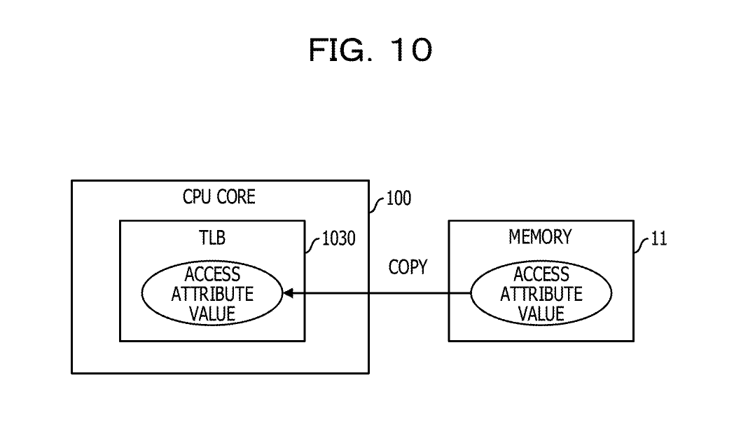

First, the data managing section 1051 reads, from an attribute storage region of the memory 11, an access attribute value corresponding to a segment of an address specified in the command and writes the read access attribute value in a predetermined region of the TLB 1030 of the memory managing unit 103 (in step S41 illustrated in FIG. 9). In step S41, the access attribute value stored in the memory 11 is copied to the TLB 1030, as illustrated in FIG. 10, and is used by the determining section 1052 in step S45 described later.

For example, if the load command is “Load address-A register-X with ASI-1”, the access attribute value is read from an attribute storage region corresponding to a segment of address-A. This load command indicates that “a value of an ASI-1 register is treated as an access key and data is read from address-A of the memory 11 and loaded in register-X”. In this case, “register-X” is a general-purpose register 101, for example.

The data managing section 1051 acquires an access key from an ASI register 102 specified in the command (in step S43).

The determining section 1052 determines, based on the access attribute value written in the TLB 1030 in step S41 and the access key acquired in step S43, whether or not access related to the command is possible (in step S45).

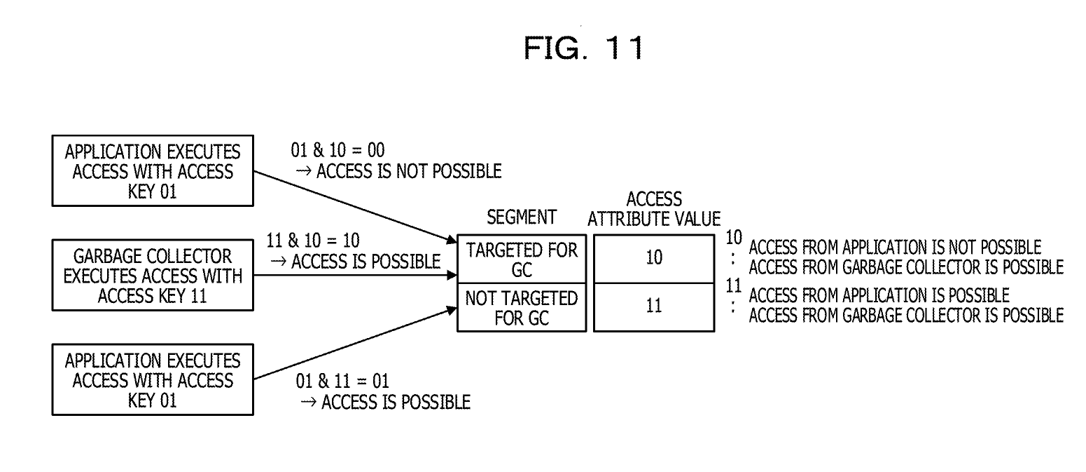

The process executed in step S45 is described with reference to FIG. 11. Different access attribute values are assigned to the segments based on whether or not the segments are targeted for the garbage collection. If a segment is targeted for the garbage collection (or if access from the application is not possible and access from the garbage collector is possible), “10” is assigned to the segment. If the segment is not targeted for the garbage collection (or if access from the application and the garbage collector is possible), “11” is assigned to the segment. An access key “01” is set for access from the application, while an access key “11” is set for access from the garbage collector. The AND operation is executed between the access attribute value and the access key. If two bits of the result of executing the AND operation are “00”, the application has accessed a segment targeted for the garbage collection and the access is not permitted. In this case, a hardware exception is generated and the GC handler starts to be executed. If the two bits of the result of executing the AND operation are not “00”, the application has accessed a segment that is not targeted for the garbage collection or access has been executed by a section other than the application and is permitted and a hardware exception is not generated.

If the access related to the command is possible (Yes in step S47), the data protector 105 notifies the computing unit 104 that the access related to the command is possible. In response to the notification, the computing unit 104 executes the access in accordance with the command via the memory managing unit 103 (in step S49). Then, the data protector 105 causes the detection process to return to the original process illustrated in FIG. 7 and terminates the detection process.

If the access related to the command is not possible (No in step S47), the data protector 105 generates a hardware exception and causes the detection process to return to the original process illustrated in FIG. 7.

Return to the description of FIG. 7. If the hardware exception is generated in the detection process (in step S23), the determining section 1052 of the data protector 105 transfers control to the GC handler (in step S25). By this transfer, the process of the application is stopped and the GC handler starts to be executed.

The first processing section 1101 of the GC handler determines whether or not an object to be accessed has been copied by the garbage collector to a segment that is a copy destination (in step S27). The object to be accessed is identified by an address specified in the load or store command. Since a flag indicating whether or not the object has been copied is set in a header of the object, the flag is used.

If the object to be accessed has been copied by the garbage collector to the segment that is the copy destination (Yes in step S29), the GC handler may not copy the object and the process proceeds to step S32.

If the object to be accessed has not been copied by the garbage collector to the segment that is the copy destination (No in step S29), the first processing section 1101 copies the object to be accessed to the segment that is the copy destination (in step S31).

The first processing section 1101 identifies an address of the segment that is the copy destination of the object to be accessed (in step S32). In step S32, the address stored in a region of the object to be accessed is identified, for example. Alternatively, a table in which addresses of objects to be accessed are associated with addresses of copy destinations of the objects may be prepared, and the address of the copy destination may be identified from the table.

The second processing section 1102 updates a reference pointer (or a reference pointer to be used by the application for access) of the access source to the address of the copy destination (in step S33).

The second processing section 1102 returns the control to the access source (or the application in this case) (in step S35). By this return, the process of the GC handler is stopped and the stop of the process of the application is canceled.

Then, the access source (or the application in this case) uses the updated reference pointer to execute the access (in step S37).

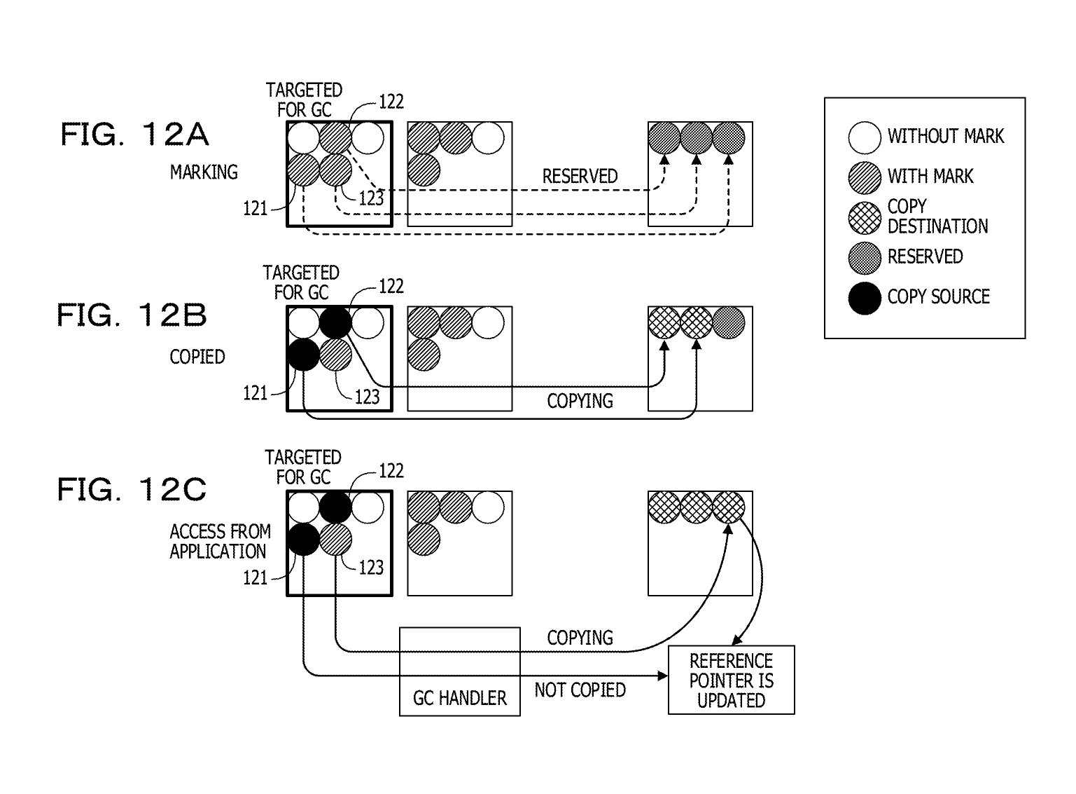

Next, the garbage collection according to the embodiment is described in detail with reference to FIGS. 12A, 12B, and 12C. As illustrated in FIG. 12A, in a phase of giving the mark to live objects within a segment targeted for the garbage collection, regions in which the objects are arranged are reserved in a segment that is a copy destination. An object to which the mark is not given is not copied and a region is not reserved for the object to which the mark is not given.

As illustrated in FIG. 12B, the live objects within the segment targeted for the garbage collection are copied to the reserved regions. In this case, since the live objects are copied in order, live objects 121 and 122 that have been completely copied and a live object 123 that has yet to be copied exist.

It is assumed that access is executed by the application in a state illustrated in FIG. 12B. As illustrated in FIG. 12C, regarding access to the live object 121, since the copying of the live object 121 is already completed, the GC handler does not copy the live object 121 and updates the reference pointer and an increase in a time period for stopping the application is suppressed. Regarding access to the live object 123, since the copying of the live object 123 is not completed, the GC handler updates the reference pointer after copying the live object 123. This may inhibit an inconsistency in data.

As described above, according to the embodiment, if the application accesses a segment that is not targeted for the garbage collection, the access is permitted and it is possible to avoid the stop of the application. In addition, if the application accesses a segment targeted for the garbage collection and an object to be accessed is already completed, the reference pointer is updated and the process of the application is restarted. Thus, the time period for stopping the application is reduced. If the copying of an object to be accessed is not completed, the copying may be completed before copying by the garbage collector and the time period for stopping the application is reduced.

In addition, since the determination of whether or not access is possible is executed by the data protector 105 that is the hardware module, a time period for the determination may be reduced.

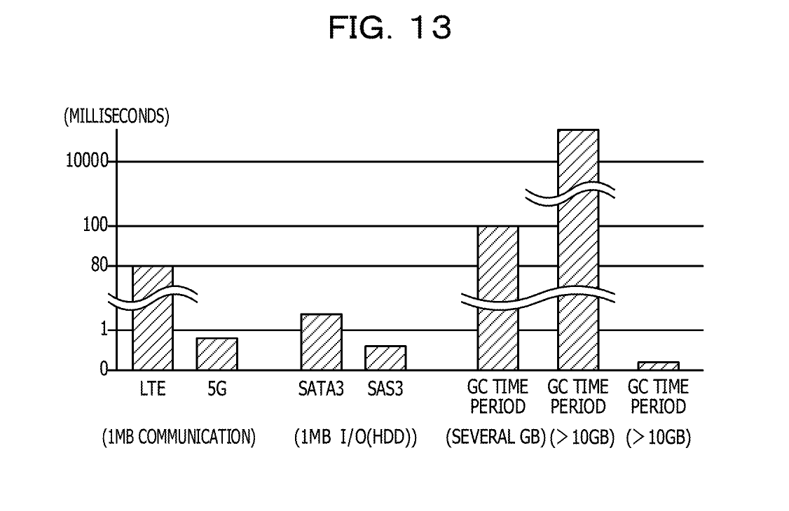

A reduction in the time period for stopping the process of the application is described with reference to FIG. 13. FIG. 13 illustrates the comparison of the communication rate of Long Term Evolution (LTE) with the communication rate of the 5th Generation (5G) and the comparison of the data transfer rate of Serial ATA 3.0 (SATA3) with the data transfer rate of Serial Attached SCSI 3.0 (SAS3) as a reference. If the size of a memory is several GB, it takes approximately 100 milliseconds to complete garbage collection. If the size of the memory is larger than 10 GB, it takes 10000 milliseconds or longer to complete the garbage collection. On the other hand, in the embodiment, even if the size of the memory is larger than 10 GB, it may take less than 1 millisecond to complete the garbage collection.

Although the embodiment is described, the embodiment is not limited to the above description. For example, the block configuration of the aforementioned information processing device 1 may not match the actual program module configuration of the information processing device 1.

The data retention configuration described above is an example and is not limited to the configuration described above. In the process flows, the orders of the processes may be changed as long as the results of the processes do not change. In the process flows, two or more of the processes may be executed in parallel as long as the results of the processes do not change.

The functions of the data protector 105 may be implemented as software. Specifically, the functions of the data protector 105 may be achieved by causing the computing unit 104 to execute a command.

The embodiment is summarized as follows.

A memory management method according to a first aspect of the embodiment includes: (A) a process of identifying, from a region included in a region of a memory and storing an address of a destination of data within a first region included in the region of the memory and allocated to software (for example, the application in the embodiment), a second address (for example, the address of the copy destination in the embodiment) within a second region that is a destination of data at a first address when a request indicating that the data at the first address within the first region is an access destination is received from a process of the software during a time period from the start to end of a data movement process of moving, to the second region included in the region of the memory, data that is included in data (for example, an object in the embodiment) within the first region and is not data that is not accessed by the process of the software; and (B) a process of changing the access destination of the request from the first address to the second address.

Even if access from the process of the software to the region targeted for the data movement process is executed during the data movement process, data at the second address may be accessed. Specifically, an inconsistency in the data may be inhibited and a time period for stopping the process of the software may be reduced.

In addition, the memory management method may further include (C) a process of determining whether or not the data at the first address has been copied to the second address. In the process of changing the access destination of the request from the first address to the second address, (b1) if it is determined that the data at first address has been copied to the second address, a reference pointer including the first address may be updated to the second address. It may be ensured that the data has been copied to the second address.

In addition, the memory management method may further include (D) a process of copying, if it is determined that the data at the first address has not been copied to the second address, the data at the first address to the second address. In the process of changing the access destination of the request from the first address to the second address, (b2) when the process of copying the data at the first address to the second address is completed, the reference pointer including the first address may be updated to the second address. If the data is not stored at the second address, the data is copied, the access is restarted by the process of the software, and the time period for stopping the process of the software may be reduced.

In the process of identifying the second address, (a1) it may be determined whether or not the request has been received from the process of the software during the time period from the start to end of the data movement process, based on information included in the request and indicating an access source and information set in the memory and indicating whether or not the first region is targeted for the data movement process. By executing the determination, the request to be detected may be detected without a detection error.

In addition, the memory management method may include (E) a process of setting, in the memory, information indicating whether or not the regions of the memory are targeted for the data movement process.

A memory managing device according to a second aspect of the embodiment includes (F) a memory (for example, the memory 11), (G) an identifying section (for example, the first processing section 1101) that identifies, from a region included in a region of the memory and storing an address of a destination of data within a first region included in the region of the memory and allocated to software, a second address within a second region that is a destination of data at a first address when a request indicating that the data at the first address within the first region is an access destination is received from a process of the software during a time period from the start to end of a data movement process of moving, to the second region included in the region of the memory, data that is included in data within the first region and is not data that is not accessed by the process of the software; and (H) a changing section (for example, the second processing section 1102) that changes the access destination of the request from the first address to the second address.

A program that causes a processor to execute the aforementioned method may be generated and the program may be stored in a storage device or a computer-readable storage medium such as a flexible disk, a CD-ROM, a magneto-optical disc, a semiconductor memory, or a hard disk. Intermediate results of the processes are temporarily stored in a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a memory management program that causes a computer to execute a process, the process comprising:
when a request indicating that data at a first address within a first memory region of a memory is an access destination is received from a process of a software during a time period from the start to end of a data movement processing, obtaining a second address within a second memory region of the memory, the data movement processing including moving data stored in the first memory region to the second memory region; and
changing the access destination of the request from the first address to the second address.

2. The non-transitory computer-readable storage medium according to claim 1, wherein the process comprises:
determining whether or not the data at the first address has been copied to the second address; and
changing, in the changing, a reference pointer including the first address is updated to the second address when it is determined that the data at the first address has been copied to the second address.

3. The non-transitory computer-readable storage medium according to claim 2, wherein the process comprises:
copying the data at the first address to the second address when it is determined that the data at the first address has not been copied to the second address; and
changing, in the changing, a reference pointer including the first address is updated to the second address when the copying is completed.

4. The non-transitory computer-readable storage medium according to claim 1, wherein the process comprises:
determining whether or not the request is received from the process of the software during the time period based on information indicating an access source and based on information indicating whether or not the first memory region is targeted for the data movement processing.

5. The non-transitory computer-readable storage medium according to claim 4, wherein
the memory includes a plurality of memory regions including the first memory region and the second memory region; and
wherein the process comprises:
setting information indicating whether or not each of the plurality of memory regions is targeted for the data movement processing.

6. The non-transitory computer-readable storage medium according to claim 1, wherein
the data movement processing is a processing that moves the data other than specified data to the second memory region, the specified data being data that is not accessed by the process of the software.

7. The non-transitory computer-readable storage medium according to claim 1, wherein the process comprises:
obtaining, in the obtaining, the second address from a region, in the first memory region, that stores an address of a copy destination for the data stored in the first memory region.

8. The non-transitory computer-readable storage medium according to claim 1, wherein
the data movement processing is a garbage correction for the memory.

9. A memory managing device comprising:
a memory including a first memory region and a second memory region; and
a processor coupled to the memory and the processor configured to:
when a request indicating that data at a first address within the first memory region is an access destination is received from a process of a software during a time period from the start to end of a data movement processing, obtain a second address within the second memory region, the data movement processing including moving data stored in the first memory region to the second memory region; and
change the access destination of the request from the first address to the second address.

10. A memory management method executed by a computer, the memory management method comprising:
obtaining first information indicating an access source from an instruction information regarding an access to data stored in a first memory region of a memory;
obtaining second information from the memory, the second information indicating whether or not the first memory region is targeted for a garbage collection;
determining whether or not the access satisfies a first condition based on the first information and the second information, the first condition including that the access is an access from a process of a specified software and that the first memory region is targeted for the garbage collection;
stopping the process of the specified software when the access satisfies the first condition; and
allowing the access when the access does not satisfy the first condition.

11. The memory management method according to claim 10, wherein the memory management method comprises:
determining, when the access satisfies the first condition, whether or not the data to be accessed has been copied to a copy destination by the process of a program for executing the garbage collection;
updating, when the data to be accessed has been copied, a reference pointer to be used for the access to an address of the copy destination; and
canceling the stop of the process of the specified software after the updating.

12. The memory management method according to claim 11, wherein the memory management method comprises:
copying the data to the copy destination when the data to be accessed has not been copied;
updating, after the copying, a reference pointer to be used for the access to an address of the copy destination; and
canceling the stop of the process of the specified software after the updating.
